(19) United States
(12) Patent Application Publication
(10) Pub. No.: US 2013/0204863 A1
(43) Pub. Date: Aug. 8, 2013

(54) System and Method for Displaying Search Results

(71) Applicant: Rod Rigole, Lake Forest, CA (US)

(72) Inventor: Rod Rigole, Lake Forest, CA (US)

(21) Appl. No.: 13/366,282

(22) Filed: Feb. 4, 2012

(51) Int. Cl. G06F 17/30

(52) U.S. Cl. 707/722; 707/E17.108; 707/E17.032

(57) ABSTRACT

In a computer implemented method, a credibility rating is requested and received, or web activity is tracked, from a web user on a web page. A search request is received from a searcher, and a plurality of links is selected, including a link to the web page to display as search results to the searcher. The link to the web page is then displayed within the search results in an order based, at least in part, on the credibility rating or web activity. Multiple credibility ratings or user web activities on that web page from other users can also be received and stored, and the order of display can be based on these as well. The order of display may be based more on credibility ratings or web activity tracked from web users affiliated with the searcher in a social network.

### BACKGROUND OF THE INVENTION

Conventional search engines return a list of links to web pages, products, images, etc., to a searcher based on relevancy to an entered search term. They are typically listed in an order of relevance, which the search engine has determined through use of various algorithms. In order for a search engine to be useful to a searcher, it should return results in which the searcher would be interested, without the searcher needing to follow an excessive number of links or scroll through an excessive number of search engine results.

With this aim, several search engine algorithms have been developed, which take into account characteristics of a web page, such as the number of times a key word is present in the content, meta-tags, length of time the web page has been in existence, key terms existent in the domain name, title, etc. These methods are easily circumvented, however, as web sites attempting to appear higher in a search engine's results may artificially increase the number of key words in visible or invisible form in the content, select numerous and irrelevant domain names, titles, and meta-tags, etc.

In addition to the circumvention problems discussed above, relevancy is also difficult to determine without human intelligence weighing into the algorithm. In one method, a searcher's own behavior is used to refine that searcher's results, such as by allowing the searcher to pursue links in a first results window, analyzing the user's activity when following, not following, etc., certain links in that first window, and dynamically refining the search results in a second results window. This method may increase the relevance of search results based on the analyzed intention of the searcher, but it still requires the searcher to go through several steps to achieve relevant results. The intelligence gleaned from the searcher's behavior is also limited to the content of the links the searcher clicks through, and if those links are irrelevant already, the results in the second window may be just as irrelevant.

Still other methods attempt to analyze the searcher's computer system, including open applications, location of the searcher, demographics, past search terms, past links clicked by the user, etc. These search engines may lack the privacy some searcher's prefer and may also require a large amount of historical data of the searcher's behavior to be effective. The relevancy is also limited to the specific person searching.

Some search engines attempt to generalize the intelligence gleaned from human interest by using a “social search” feature to determine relevancy of links. One such system counts the number of other pages that link to a particular page. Viewing these links as indication of human interest, the search engine assigns a higher “page rank” to pages that are the target of many links. This method of ranking a page's credibility, however, is easily circumvented by exchanging links with other sites or inter-linking all of a content-provider's pages to each other.

Still another method attempts to use conscious human indications of web page quality by allowing users to promote or demote various links from within the search results, based on whether the searcher likes that particular link. Information from many searchers' promotions and demotions are aggregated, averaged and used to determine the popularity of a web page. These search engines, however, may be circumvented by web page owners improperly promoting their own pages multiple times and demoting their competitors' pages to skew the quality ratings in their favor.

### SUMMARY OF THE INVENTION

In one embodiment of a method according to the invention, a credibility rating of a web page is requested of a web user, and the credibility rating is received and stored in a credibility rating database. A search request is received from a searcher, and a plurality of links is selected, including a link to the web page, to display as search results to the searcher. The link to the web page is then displayed within the search results in an order based, at least in part, on the credibility rating. Credibility ratings of that web page can also be received from other web users and stored, and the order of display can be based on these ratings as well.

In another embodiment, the method determines whether the web user had previously submitted a credibility rating for the web page, and the order is based more on the credibility rating if the web user did not previously submit. In yet another embodiment, the credibility rating is only considered in the ordering if the web user did not previously submit. Whether the web user previously submitted a credibility rating in some embodiments is determined by comparing identity information, such as an IP address or a unique login identification, to a database of identity information from previously submitted credibility ratings of the web page.

In one embodiment, the method determines whether the web user is affiliated with the searcher in a social network and bases the order of the web page more on the credibility rating of that web user than another web user's credibility ratings, who is not affiliated with the searcher in the social network or who is not affiliated as closely with the searcher as the first web user.

In yet another embodiment of the invention, a method includes tracking web activity of a first web user on a web page, receiving a search request from a searcher, the searcher different from the web user, selecting a plurality of links including a link to the web page to display as search results to the searcher, and displaying the link to the web page within the search results in an order based, at least in part, on the tracked web activity.

In various embodiments, the web activity includes an amount of time spent on the web page, an amount of time spent on a web site to which the web page belongs, a number of clicks on a website to which the web page belongs, whether a purchase was made, subscription to a service (such as a mailing list, blog, etc.), whether the web user blocked the web page, the determined credibility or level of trust of the web user, etc. The web activity of a web user affiliated in a social network to the searcher may also be weighed more heavily in the order of display than the web activity of unaffiliated or more distantly affiliated web users. Likewise, the method may additionally determine whether the web user's web activity was previously tracked on the web page, and the order of display can be based on the web activity more, or only, if the web user was not previously tracked on the web page.

In other embodiments of the invention, a computer includes a processor and a memory coupled to the processor, the memory including computer-program instructions executable by the processor for performing all or portions of the methods described above. In additional embodiments, one or more computer-readable media store computer-program instructions for performing the above methods. One or more computers, such as a remote server and one or more computers operated by the web user and the searcher, may each include a processor and a memory coupled to the processor. Portions of the computer-program instructions included in the memory may be performed by different ones of the one or more computers.

### BRIEF DESCRIPTION OF THE DRAWINGS

FIG. 1 is a diagrammatic view of one embodiment of a system according to the invention.

FIG. 2A is a depiction of search results according to one embodiment of the invention when a first web user is socially affiliated with the searcher.

FIG. 2B is a depiction of search results according to the embodiment in 2A when the first web user is more distantly affiliated with the searcher.

FIG. 3 is a process flow diagram according to one embodiment of a method according to the invention.

FIG. 4 is a process flow diagram according to another embodiment of a method according to the invention.

### DETAILED DESCRIPTION OF THE INVENTION

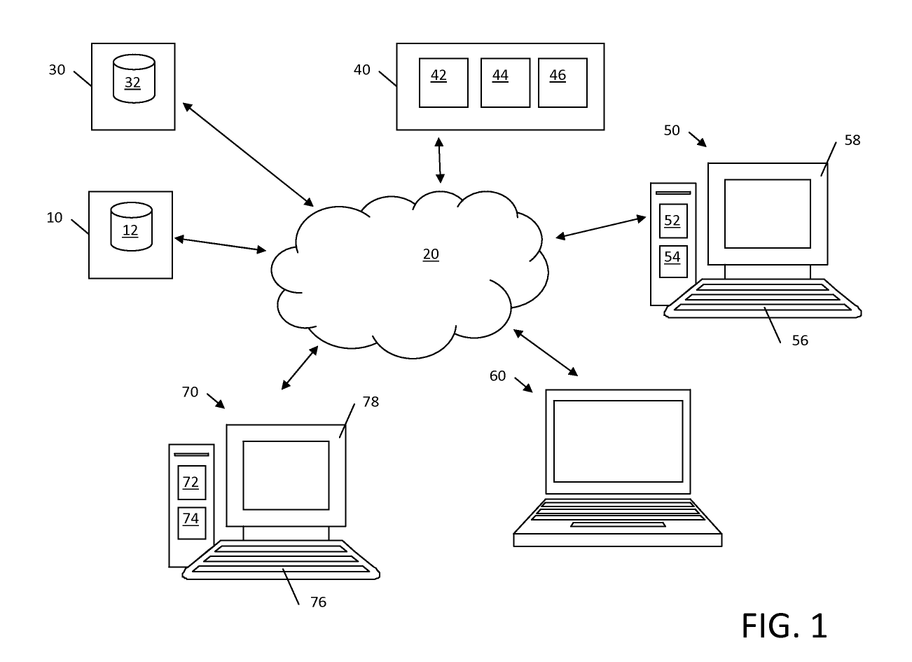

FIG. 1 shows a diagrammatic view of one embodiment of a system according to the invention. Server 10 is coupled to a network 20, such as the Internet. Also coupled to the network are a social affiliation server 30, a website server 40, first and second web user terminals 50, 60 and a searcher terminal 70.

The social affiliation server 30 includes a social affiliation database 32, containing information relating to identity of members, login information, and information related to the affiliation of members to each other. The information related to the affiliation may include information on how closely or distantly the members are affiliated, such as through designation of one member in another member's trusted circle, whether the member is only a friend of a friend, etc. The information from the social affiliation database 32 may be used to display affiliation information related to the first or second web user operating the first or second web user terminals 50, 60. Likewise, information such as login information and selection of member affiliations may be received by the social affiliation server 30 via the network from the first and second web user terminals 50, 60 and stored in the social affiliation database 32.

Website server 40 includes content files 42 for displaying a web site, including content of a web page 44, as well as interactive modules 46, such as forms for allowing web users to subscribe to newsletters, purchase products, etc.

Each of the servers 10, 30, 40 and terminals 50, 60, and 70 include a processor 52 and memory 54 (shown only in connection with first web user terminal 50 and searcher terminal 70), which includes computer-program instructions executable by the processor 52, 72 for performing various tasks as described herein. The terminals 50, 60, and 70 also include an interface 56, 76 such as a keyboard or mouse operable by a web user or searcher at the terminal, and a display 58, 78. The display 58, 78 might dually perform as an interface 56, 78 in some embodiments. The terminals 50, 60, and 70 may be in the form of a desktop or laptop computer, mobile telephone, or other device capable of connecting to network 20. It is also within the scope of the invention for the terminal to connect to network 20 via additional, intermediate networks or devices (not shown).

Server 10 includes a database 12 which may store information on credibility ratings, tracked web activity, web user identity, and web content relevancy. Although this embodiment describes only one database, it is also within the scope of the invention for separate databases to hold portions of the above-described information. The database 12 receives and stores credibility ratings received from web user terminals, such as the first web user terminal 50.

Credibility ratings are ratings given by the web users related to whether they approve of, like, or otherwise view a particular web page as credible. “Credible” may mean that the site is useful, entertaining, important, official, or legitimate in some way (e.g., selling authentic goods, not merely a parked page, etc.). The credibility ratings may be in the form of, for example, “yes” and “no” links, “like” buttons, a 1-10 rating, etc. submitted via the interface 56. The request for credibility ratings may be displayed on the display 58 while the first web user is viewing, for example, content on the web page itself, a link to the web page in search results, an email, or content on a separate website.

After the credibility rating is submitted by the first web user via interface 56, it is received by server 10 via network 20. Information indicating the web page to which the credibility rating relates, such as the web page hosted at website server 40, is also sent via the network 20 to the server 10, and this information is correlated with the credibility rating in the database 12. Information relating to the identity of the first web user, such as, for example, login identification, IP address, name, etc., may also be sent, stored and correlated with the credibility ratings in the database 12.

In one embodiment, the web page indication and the identity information are compared to previously submitted credibility ratings in the database 12 to determine whether the first web user has already submitted a credibility rating for the web page. If so, the new credibility rating may not be saved or it may be saved in the database 12 with an indication that it is a duplicate or second rating, which can therefore be discounted when later assessing the web page's credibility.

In addition to receiving credibility ratings submitted by the first web user, the server 10 may also receive tracking information related to the first web user's web activities. These activities may include, for example, signing up for a newsletter or purchasing a product from the web site to which the web page belongs. It might also include clicking several links on the web page, spending a long or short time on the web page or the web site to which the web page belongs, blocking the web page, etc. This tracking information can then be sent via network 20 to server 10 and stored in the database 12 so that identity information of the first web user and an indication of which web page the tracking information relates to are correlated. Repeated visits to the web page may indicate that the web page is more credible, but repeated visits of short durations may indicate attempts by the user to skew the ratings, so they may be discounted accordingly.

The server 10 may also rate the first web user's reliability, or level of trust, based on the tracked web activity or other information about the web user that does not relate to the activity on the web site to which the web page belongs. For example, if the first web user subscribed to a newsletter, purchased merchandise, was a member of a previous searcher's social network, spent a long time on a previous web page, etc., the first web user may be determined to be a legitimate user whose credibility ratings and tracked web activity is more reliable. Likewise, if the first web user went to the first web page multiple times within a short time period with very little activity, the web user's reliability/level of trust may be determined to be low.

In another embodiment, the IP address of the first web user can be received and compared to a list of trusted IP addresses, such as IP addresses of previously-vetted web users or previous submitters of acceptable credibility ratings. If the IP address is found on the trusted list, the first web user's reliability/level of trust may be determined to be higher than if it were not. Likewise, the IP address of the first web user can be compared to a list of untrusted IP addresses, and the reliability/level of trust can be determined to be lower if the IP address is found on that list than if it were not found on the list. This reliability/level of trust rating may be correlated to the first web user in the database 12.

Another method of determining a reliability or level of trust of the first web user includes determining a geographic location of the user through known methods and determining whether that geographic location is within preferred geographic regions, unpreferred geographic regions, or neither. A region may be pre-determined to be a preferred geographic region if, for example, web users from that region tend to be more reliable. Likewise, a region may be pre-determined to be an unpreferred geographic region if, for example, web users from that region tend to have a disproportionate number of hackers, spammers, people who would not normally speak the language displayed on the first web page, etc., which may indicate that web activity and credibility ratings from those users may be less reliable or skewed.

The first web user's reliability/level of trust may also be determined based on whether the terminal of the first web user is using automated technical means to perform the web activity. Such automated technical means may be detected using conventional methods that are well-known to those skilled in the art.

The second web user's web activities on the web page may also be tracked and/or their credibility ratings for the web page may be submitted and stored in the database 12 and correlated with information indicating the web page and/or identity information of the second web user, as discussed above.

The database 12 may also include web content relevancy information correlated to particular web pages to determine, for example, if web page content, meta-data, etc. is relevant to a particular keyword.

Although the above information is described as being saved in database 12 of server 10, it is also within the scope of the invention for this information to be stored in different locations, such as social affiliation server 30, website server 40, first and/or second web user terminals 50, 60, searcher terminal 70, or a location different from any of these. It is also within the scope of the invention for some of the above information to be stored in one location and others of the above information to be stored in different locations, such as those mentioned above.

A searcher's terminal 70 includes a processor 72, memory 74, an interface 76, and a display 78. The interface 76 may also function as the display 78. A searcher may submit a search request containing a search term via the network 20 to the server 10. The server 10 may check the search term against the web content relevancy information to select a series of links to display as search results on the searcher's display 78. Assuming that the web page was determined to be relevant, a link to the web page is displayed in a particular order, or rank, within the search results.

In one embodiment, the server 10 bases the order of display of the link to the web page in the search results, at least in part, on the credibility ratings stored in the database that are correlated to the web page. If many low credibility ratings are stored for the web page, for example, the link may be shown further down in the search results than it would have been if many high credibility ratings for that web page are stored.

In other embodiments, the order of display of the link to the web page in the search results is based, at least in part, on the information tracked and stored from the first web user and the second web user. For example, if the first and second web users spent a long time on the first web site, the server 10 will rank the link to the first web site higher in the search results than if they spent a short amount of time on the first web site. Likewise, the link may be displayed in a higher position in the search results if the first and/or second web users subscribed to a newsletter, purchased a product, or clicked on a large number of links on the website to which the web page belongs than if the web users did not do so. On the other hand, if the tracked information indicated that the web users blocked the page and/or website, spent a small amount of time on the web page and/or website, etc., the server 10 may rank the link to the web page lower than if the web users had not done so. The server 10 may also rank the link to the web page based more on previously tracked information from the first web user related to the web page than later tracked information from the first web user related to that same web page. Conversely, later tracked information may be weighed more heavily in the search results ranking than earlier tracked information.

Reliability ratings of the first and second web users may also be taken into account by the server 10 when ranking the links in the search results. If the database 12 indicates that the first web user has a high reliability rating, for example, and that the second web user has a low reliability rating, the first web user's tracked information and/or credibility rating may be given greater weight than is the second web user's tracked information and/or credibility rating.

The server 10 may also receive social affiliation information from the searcher terminal 70 and the social affiliation database 32. The server 10 may compare this information to identification information stored in the database 12 and, through cross-referencing the identification information with the social affiliation database 32, determine whether the first and/or second web user is socially affiliated with the searcher.

If the searcher is socially affiliated with the first web user, such as being “friends” or in a common “circle” in a social network, but not with the second web user, the server 10 may base the order of display of the link more on the first web user's tracked activities and/or credibility ratings than on the second web user's tracked activities and/or credibility ratings. Likewise, if the searcher is socially affiliated more closely to the first web user than to the second web user, the first web user's tracked activities and credibility ratings may be weighted more heavily in search results ranking than the second web user's tracked activities and credibility ratings. Some examples of closer social affiliations are trusted friend circles vs. peripheral friend circles or direct acquaintances vs. friends of friends (i.e., second order and more distant contacts).

While the searcher is following links in the search results, the searcher's web activity and credibility ratings may also be tracked, correlated, and saved, as described above in relation to the first and second web users.

Although the server 10 is described as comparing the searcher's social affiliations and determining the order of links that are displayed on the searcher's terminal 70, it is also within the scope of the invention for the searcher's own terminal to perform these operations through, for example, queries to the database 12 and the social affiliation database 32, or for some operations to be performed by one server or terminal and other operations to be performed by other servers or terminals.

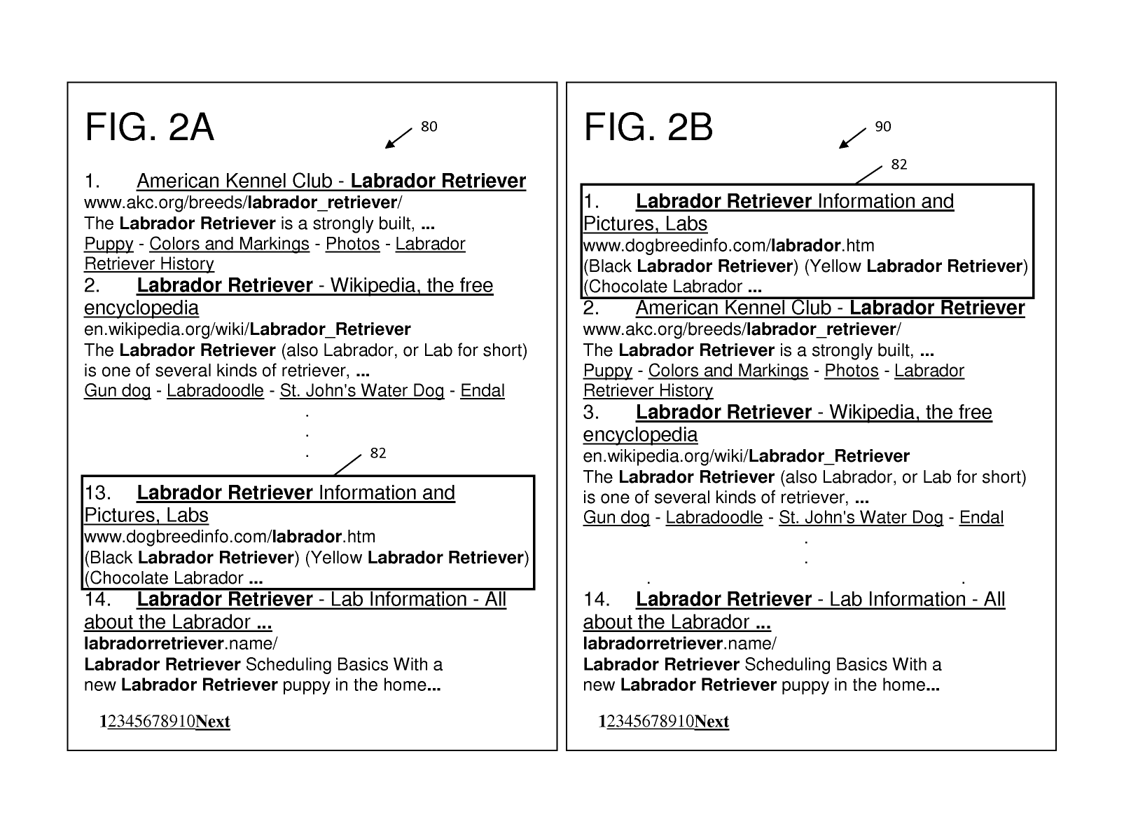

FIGS. 2A and 2B depict search results displayed to different searchers according to one embodiment of the invention. In this embodiment, both the first and second web users have rated the credibility of a web page. The first web user has rated the credibility of the web page as a “3” on a scale from 1-10, and the second web user has rated the same web page as a “9” on the same scale. In FIG. 2A, the search results 80 are shown after it is determined that the searcher is socially affiliated as a close friend of the first web user and is more distantly affiliated (e.g., only a friend of a friend) with the second web user. A link 82 to the web page is displayed in the search results in an order that is based more on the low credibility rating of the first web user than the high credibility rating of the second web user. In FIG. 2B, different search results 90 are shown to a second searcher after it is determined that the searcher is more closely affiliated with the second web user than the first web user. As shown, the link 82 to the web page is displayed in the search results in an order that is based more on the credibility rating given by the second web user than by the first web user.

Although FIGS. 2A and 2B depict alternate search results in terms of social affiliation, the links may be similarly ordered based on average credibility ratings for the site, information tracked from the web users as described above, and/or with different weights given to different tracked activities based on social affiliation, web user reliability ratings, whether the web users had previously saved ratings or tracked activities for the web page, etc.

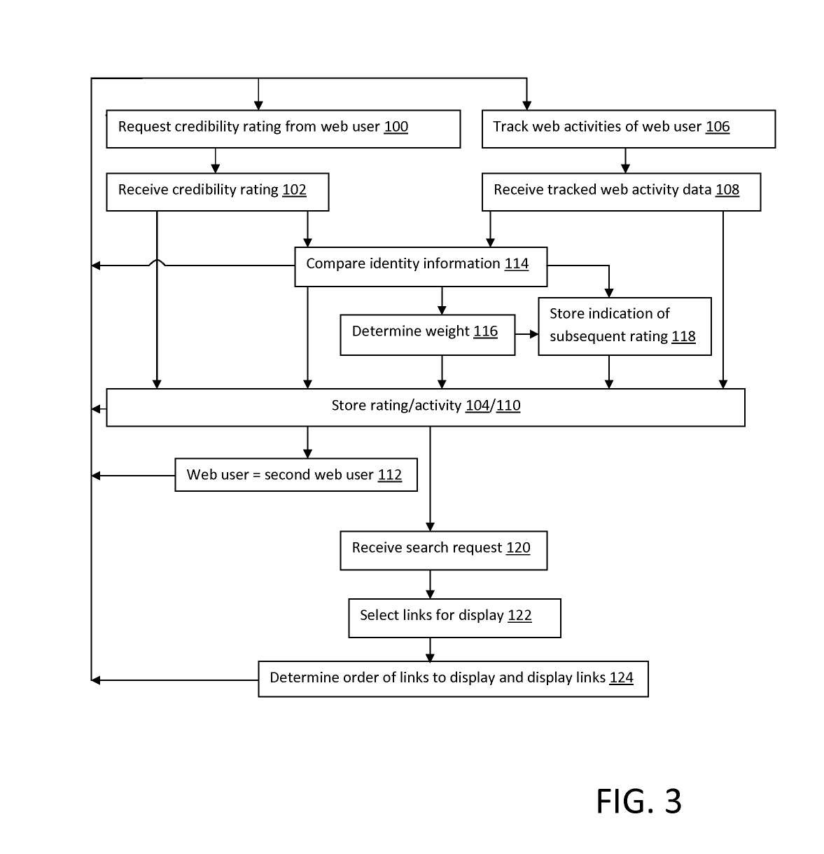

FIG. 3 shows a process flow diagram according to one embodiment of the invention. A credibility rating is requested 100 from a first web user regarding the credibility of a web page. As discussed above, this request may be displayed on the web page itself, search results, a different web page, an email, etc. After the first web user submits the credibility rating, it is received 102 and stored 104 in, for example, a credibility rating database.

While the first web user is performing various activities on the web page and the website to which it belongs, the web activities of the first web user may also be tracked 106, received 108, and stored 110 in, for example, a tracked activity database or in a same database as the credibility ratings. The tracked web activity may include, for example, an amount of time spent on the web page, an amount of time spent on a web site to which the web page belongs, a number of clicks on a website to which the web page belongs, whether a purchase was made, subscription to a service (such as a mailing list, blog, RSS feed, etc.), whether the web user blocked the web page, the determined credibility or reliability of the web user, etc.

A second credibility rating relating to the web page may also be requested 100, received 102, and stored 104 from a second web user 112 and/or their web activities on the web page/web site may be tracked 106, received 108, and stored 110, as described above.

The storage of the credibility ratings 104 and/or web activities 110 may be conditioned on whether the web user had previously submitted a credibility rating of or had been tracked previously on the web page. Whether the web user previously submitted a credibility rating or was previously tracked may be determined by comparing identity information 114, such as an IP address or a unique login identification, to a database of identity information from previously submitted credibility ratings of or tracked activities on the web page. Alternatively, an initial or subsequent rating or tracked activity can be weighted differently than the other ratings or activity 116, or an indication that the rating or activity is a subsequent rating or activity may be stored 118 along with the rating or activity to be taken into account when displaying search results. The database of identity information may be the same or different from the database containing credibility ratings and/or tracked web activities.

A search request is received 120 from a searcher, and a plurality of links is selected 122, including a link to the web page to display as search results to the searcher. This selection may be based, for example, on comparison of a search term in the search request to a database of content information or keywords correlated to the web page. The link to the web page is then displayed 124 within the search results in an order based, at least in part, on the credibility rating 104 and/or tracked web activity 110 related to the web page. The order may further be based on a determination 118 of whether the ratings and/or tracked activities were initial or subsequent ratings/tracked activities, etc.

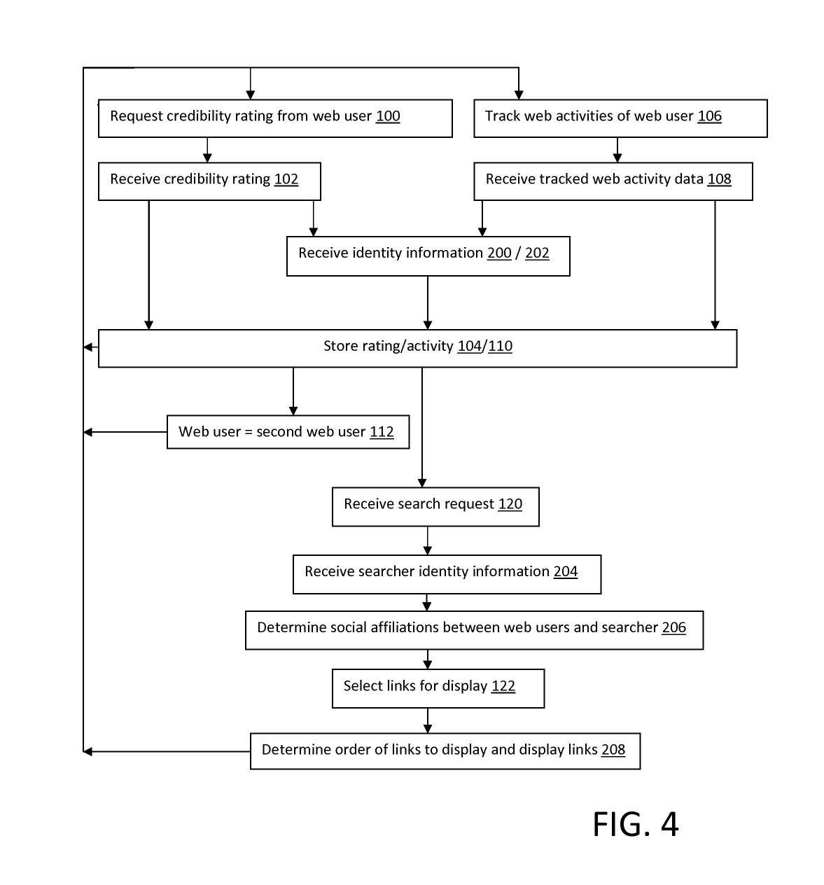

FIG. 4 depicts a process flow diagram of a method according to another embodiment of the invention. Like the method described in FIG. 3, credibility ratings and/or web activities of first and second web users on a web page are received 102, 108, tracked 106, and stored 104, 110, a search request is received 120 from a searcher, and links, including a link to the web page, are selected 122 to display as search results. In addition, identity information related to social affiliation on a social network is received from the first 200 and/or second 202 web users and the searcher 204. Social affiliation between the searcher and the first web user and/or the second web user is determined 206, and the order of display of the link to the web page in the search results is based 208 more on the credibility ratings and/or tracked web activities of the more closely affiliated of the first and second web users than the less closely affiliated or unaffiliated of the first and second web users.

The embodiments of the invention described herein are illustrative, rather than restrictive. Modification may be made without departing from the spirit of the invention as defined by the following claims and their equivalents.

1. A method of displaying search results comprising:
requesting a credibility rating of a web page from a web user;
receiving and storing the credibility rating of the web user;
receiving a search request from a searcher, who is not the web user;
selecting a plurality of links including a link to the web page to display as search results to the searcher;
displaying the link to the web page within the search results in an order based, at least in part, on the credibility rating.

2. The method of claim 1, wherein the web user is a first web user, the method further comprising:
requesting a second credibility rating of the web page from a second web user, who is not the searcher; and
receiving and storing the second credibility rating from the second web user, wherein the order of display is further based on the second credibility rating.

3. The method of claim 1, further comprising determining whether the web user had previously submitted a credibility rating for the web page, wherein the order is based more on the credibility rating if the web user is determined to have not previously submitted.

4. The method of claim 3, wherein the order is based on the credibility rating only if the web user is determined to have not previously submitted.

5. The method of claim 3, wherein the determining comprises:
providing a database of identity information correlated to the web page;
receiving identity information from the web user;
comparing the identity information from the web user to the identity information stored in the database correlated to the web page.

6. The method of claim 5, wherein the identity information comprises an IP address.

7. The method of claim 5, wherein the identity information comprises a unique login identification input by the web user.

8. The method of claim 2, further comprising:
determining that the first web user is affiliated with the searcher in a social network; and
determining that the second web user is not affiliated with the searcher in the social network, wherein the order of display is based more on the first credibility rating than the second credibility rating.

9. A method of displaying search results comprising:
tracking web activity of a first web user on a web page;
receiving a search request from a searcher, the searcher different from the web user;
selecting a plurality of links including a link to the web page to display as search results to the searcher; and
displaying the link to the web page within the search results in an order based, at least in part, on the tracked web activity.

10. The method of claim 9, wherein the web activity comprises an amount of time spent on the web page.

11. The method of claim 9, wherein the web activity comprises an amount of time spent on a web site to which the web page belongs.

12. The method of claim 9, wherein the web activity comprises a number of clicks on a website to which the web page belongs.

13. The method of claim 9, wherein the web activity comprises whether a purchase was made by the web user on a web site to which the web page belongs.

14. The method of claim 9, wherein the web activity comprises whether the web user subscribed to a service on a website to which the web page belongs.

15. The method of claim 9, wherein the web activity comprises whether the web user blocked the web page.

16. The method of claim 9, further comprising determining a level of trust of the web user, and wherein the order is further based, at least in part, on the level of trust.

17. The method of claim 16, wherein the determining comprises:
receiving an IP address related to the web user; and
comparing the IP address received to a list of trusted IP addresses and/or a list of untrusted IP addresses,
wherein the level of trust of the web user is determined to be higher if the IP address is found on the list of trusted IP addresses and/or the level of trust of the web user is determined to be lower if the IP address is found on the list of untrusted IP addresses.

18. The method of claim 9, wherein the web activity is a first web activity and the web user is a first web user, the method further comprising tracking a second web activity from a second web user on the web page.

19. The method of claim 18, further comprising:
detecting that the first web user is affiliated in a social network to the searcher; and
detecting that the second web user is not affiliated in the social network to the searcher, wherein the order of display is based more on the first web activity than the second web activity.

20. The method of claim 18, further comprising:
detecting that the first web user is affiliated in a social network to the searcher; and
detecting that the second web user is affiliated in the social network to the searcher in a more distant status than is the first web user, wherein the order of display is based more on the first web activity than the second web activity.

21. The method of claim 9, further comprising, determining whether the web user was previously tracked on the web page, wherein the order is based more on the web activity if the web user was not previously tracked on the web page.

22. The method of claim 9, further comprising, determining whether the web user was previously tracked on the web page, wherein the order is based more on the web activity if the web user was previously tracked on the web page.

23. The method of claim 9, further comprising determining whether the web activity is performed through automated technical means, and wherein the order is based more on the web activity if the web activity is not performed through automated technical means.

24. The method of claim 16, wherein the determining of the level of trust comprises:
determining a geographic location of the web user; and
determining whether the geographic location is within a preferred geographic region and/or within an unpreferred geographic region, wherein the level of trust is determined to be higher if the geographic location is within the preferred geographic region and/or the level of trust is determined to be lower if the geographic location is within the unpreferred geographic region.
